(19) United States
(12) Patent Application Publication
(10) Pub. No.: US 2003/0196138 A1
(43) Pub. Date: Oct. 16, 2003

(54) Method and system of backing up data

(75) Inventor: Masakazu Ito, Kanagawa (JP)

Correspondence Address: FOLEY AND LARDNER, SUITE 500, 3000 K STREET NW, WASHINGTON, DC, 20007, US

(73) Assignee: NEC INFRONTIA CORPORATION

(21) Appl. No.: 10/409,134

(22) Filed: Apr. 9, 2003

(30) Foreign Application Priority Data
Apr. 10, 2002 (JP) 2002-107334

(51) Int. Cl. H02H 3/05

(52) U.S. Cl. 714/13

(57) ABSTRACT

Individual POS terminal units 11 to 13 which are LAN connected, realize ready and reliable data restoration and retained data call time reduction at the time of occurrence of a trouble in any POS terminal due to various causes in such a manner that data, which have heretofore been managed by a master unit and a back-up unit alone, are commonly held by all the POS terminal units.

### BACKGROUND OF THE INVENTION

This application claims benefit of Japanese Patent Application No. 2002-107334 filed on Apr. 10, 2002, the contents of which are incorporated by the reference.

The present invention relates to a method and a system of backing up data such as sales and diligence/non-diligence data to be used in a POS system (Point of Sales system) or the like, which is adapted to first food shops, super-markets or other large-scale stores and constituted by a plurality of data processing units (or POS terminal units) interconnected by data transfer line.

Heretofore, in POS system, in which a plurality of data processing units installed in shops or the like and a server having data collecting function, sales data (i.e., POS data) generated in the data processing units are real time transmitted to the server for collection processing on the server side. In such POS system, the sales data stored are Collection processed in conformity to shop rules or regulations and the like, and diligence/non-diligence or like data are managed as master data.

In a POS system with a plurality of POS terminal units connected by transfer lines (or communication lines), sales and other data are backed up such that a predetermined unit and a back-up unit mutually and commonly store the data. However, when the master unit or the back-up unit becomes inoperative due to a trouble, data restoration is disabled, so that call of sales retention data and processing of diligence/non-diligence data can no longer be made.

To cope with this problem, various proposals have been made. For example, Japanese Patent Laid-Open No. 2000-112801 discloses a system, in which a common access language is used among data base managing sections of data processing units inter-connected to one another. It is taught that in the event of occurrence of a trouble in a master data base managing section, the interconnected data processing units can readily interchange data.

Japanese Patent Laid-Open No. 2000-287868 proposes a system, in which discrimination for any communication trouble occurring in a system line between a server unit as a master unit in a shop and a POS terminal unit is made and, in the event of occurrence of a trouble, the data is re-transmitted from the POS terminal unit to the server unit in the shop. It is taught that the system efficient line tests at the time of data transmission and data back up.

Japanese Patent Laid-Open No. 7-85165 discloses a system, which is constructed such that at the time of file data collection a number of slave units function as well as a master unit function as control stations for file data collection, and is adapted to improve the data collection efficiency by dispersion processing a number or a large quantity of data from a POS terminal unit by time division basis and parallel processing. It is taught that the file collection efficiency can be improved.

Japanese Patent Laid-Open No. 10-40469 proposes a system, which, for the back-up of data among a plurality of POS terminal units, seeks to improve the reliability with a system construction that back-up data are hierarchically structured in three layers in the own POS terminal unit, other POS terminal units and shop data managing units.

Japanese Patent Laid-Open No. 2002-56422 proposes a system construction utilizing portable telephone sets as terminal units of a sales and diligence/non-diligence data managing system to permit the management with simple construction.

Japanese Patent Laid-Open No. 63-76058 proposes a system, which is constituted by a plurality of POS terminal units and an upper rank unit for one-dimensional diligence/non-diligence management of employees.

Any of the above prior art proposals, however, intends to reduce effects of any trouble, which may occur in a unit intrinsically holding data or a data transfer line for data transfer to and from the unit (such as line, hub or path in modem or system), in the event of occurrence of the trouble, with transmission of back-up data from a unit holding the data to hierarchically lower or same rank layer unit or units requiring the data. To this end, the connection (or data flow) is switched such as to cause function of a unit holding such back-up data in the system in lieu of the unit intrinsically holding the master data, or urgent back-up data (or file) interchange is brought about. However, doing so has not been so ready.

### SUMMARY OF THE INVENTION

An object of the present invention is to provide a data back-up method and system, which can preclude the problem that the occurrence of a trouble in the unit holding the master data or a data transfer line in a connection to interchange data with the unit, dictates the switching of data flow to cause function of a unit holding the back-up data in lieu of the unit intrinsically holding the master data or bringing about urgent back-up data (or file) interchange.

According to an aspect of the present invention, there is provided a data back-up method comprising the steps of: interconnecting a plurality of data processing units each having a data processing function section, a data accumulating function section and data communication function section with data transfer line, permitting interchange of own held data of the plurality of data processing units interconnected by the data transfer line and permitting accumulation of own received data in the own data accumulating function section; causing, at the time of occurrence of updating, in one of the plurality of data processing units, of data of at least a predetermined kind among the data held in the own data accumulating function section, the data processing unit concerning the updating occurrence to transmit the contents of the updating to all the other data processing units via the data transfer line; causing all the other data processing units having received the updating contents via the data transfer line to revise data held in the own data accumulating function sections to the state reflecting the updating; and allowing, in response to the revision, all the plurality of data processing units to be in a state that data of the same contents concerning at least the data of the predetermined kind is held in the own data accumulating function sections.

According to another aspect of the present invention, there is provided a data back-up method comprising the steps of: interconnecting a plurality of data processing units each having a data processing function section, a data accumulating function section and data communication function section with data transfer line, permitting interchange of own held data of the plurality of data processing units interconnected by the data transfer line and permitting accumulation of own received data in the own data accumulating function section; constituting a hierarchical control system with one of the plurality of data processing units set as a master unit and the others as slave units; causing, at the time of occurrence of updating, in one of the data processing units as the slave units, of data of at least a predetermined kind among the data held in the own data accumulating function, the afore-said slave unit concerning the updating occurrence to transmit the updated data to the data processing unit as the master unit, thereby causing revision of the contents of data in the data accumulating function section in the master unit to the state reflecting the updating; then causing the data processing unit as the master unit to transmit the data concerning the data updating to the data processing units other than the own unit and the data processing unit as the slave unit concerning the data updating via pertinent data transfer line; causing the data processing units as the slave units having received the contents of the data updating via the data transfer line to revise the contents of data held in the own data accumulating function sections to the state reflecting the data updating; and allowing, in response to the revision, all the plurality of data processing units to be in a state that data of the same contents concerning at least the data of the predetermined kind is held in the own data accumulating function sections.

At the time of occurrence of data updating, in the data processing unit as the master unit, of data of at least a predetermined kind among the data held in the own data accumulating function section, the contents of the data updating are caused to be transmitted to the data processing unit as the slave unit for the revision of the contents of the data held in the data accumulating function sections to the state reflecting the data updating. The data processing units are POS terminal units. The POS terminal units are of a type of dealing with sales data and/Or diligence/non-diligence data, the sales data and/or the diligence/non-diligence data being dealt with as data corresponding to the data of the predetermined kind. The data processing units are POS terminal units of a type dealing with sales data and/or diligence/non-diligence data, the sales data and/or diligence/non-diligence data being deal with as data corresponding to the data of the predetermined kind.

According to other aspect of the present invention, there is provided a data back-up system comprising a plurality of data processing units having a data processing function section, a data accumulating function section and a data communication function section, the data processing units being constructed such that their data communication function sections are interconnected via predetermined common data transfer line and are capable of interchanging data held in their data accumulating function sections via the data transfer line, wherein: each of the plurality of data processing units is constructed such that, at the time of occurrence of data up-dating of data of a predetermined kind among data held in the own data accumulating function section, it transmits the contents of the data updating to all the other data processing units interconnected by the data transfer line and, at the time of the contents of data updating from any other data processing unit via the pertinent data transfer line, revises the contents of the data held in the own data accumulating function section to the state reflecting the data updating; and in response to the execution of the revision, all the plurality of data processing units are allowed to be in a state that data of the same contents concerning at least the data of the predetermined kind is held in the own data accumulating function sections.

According to still other aspect of the present invention, there is provided a data back-up system comprising a plurality of data processing units having a data processing function section, a data accumulating function section and a data communication function section, the data processing units being constructed such that their data communication function sections are interconnected via predetermined common data transfer line and are capable of interchanging data held in their data accumulating function sections via the data transfer line, wherein: the plurality of data processing units are constructed such as to fit hierarchical control with the own unit set as master unit and the others as slave units or hierarchical control with the own unit set as slave unit and the others as master units; in the case with the own unit set as master unit, when data updating of data of at least a predetermined kind among data held in the data accumulating function section in any data processing unit set as slave unit occurs, the own unit as the master unit causes the contents of the data updating to be transmitted to the own unit as the master unit via the data transmission line to revise the contents of data held in the own data accumulating function section to the state reflected by the data updating, and then transmits data concerning the data updating to the data processing units other than the own unit and the data processing unit as the slave unit concerning the data updating via the data transfer line; and in the case with the own unit set as slave unit, when data updating of data of at least a predetermined kind among data held in the own data accumulating function section occurs, the own unit as the slave unit transmits the updated data to the data processing units set as the master units via the data transfer line and, when it receives data concerning data updating from any data processing unit set as master unit via the data transfer line, it revises the contents of data held in the own data accumulating function section to the state reflecting the data updating; and in response to the execution of the revision, all the plurality of data processing units are allowed to be in a state that data of the same contents concerning at least the data of the predetermined kind is held in the own data accumulating function sections.

When data updating of data of at least a predetermined kind among data held in the own data accumulating function section occurs, the own unit causes the transmission of the contents of the data updating to the data processing units as the slave units for revision of the contents of the data held in the individual data accumulating function sections to the state reflecting the data updating. The data processing units are POS terminal units. The POS terminal units are of a type dealing with sales data and/or diligence/non-diligence data. The data processing units are of a type dealing with sales data and/or diligence/non-diligence data, the POS terminal units deal with the sales data and/or diligence/non-diligence data as data corresponding to the data of the predetermined kind.

Other objects and features will be clarified from the following description with reference to attached drawings.

### BRIEF DESCRIPTION OF THE DRAWINGS

FIG. 1 is a schematic view for describing a system, to which the data back-up method according to the present invention is to be applied;

FIG. 2 is a block diagram showing the construction of the POS terminal units 11 to 13 as the data processing units having similar construction and functions shown in FIG. 1;

FIG. 3 is a view showing in details the status of the data accumulation in the memory sub-sections in the memory section in FIG. 2;

FIG. 4 is a view showing a status example of the data accumulation in the memory sub-sections in the memory section in FIG. 2;

FIG. 5 is a view for describing details of data accumulation status in the memory sub-section 28 in FIG. 2; and

FIG. 6 is a view for describing details of data accumulation status in a different example of memory sub-section 28 in FIG. 2.

### PREFERRED EMBODIMENTS OF THE INVENTION

Preferred embodiments of the present invention will now be described with reference to the drawings.

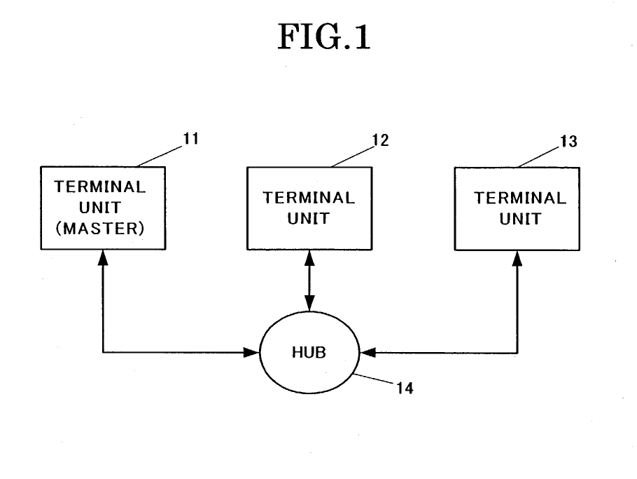

FIG. 1 is a schematic view for describing a system, to which the data back-up method according to the present invention is to be applied.

Referring to the Figure, the system comprises a plurality of data processing systems (i.e., POS terminal units in this embodiment) 11 to 13 are LAN connected via a hub 14. The POS terminal units 11 to 13 realize ready and reliable data restoration and retained data call time reduction at the time of occurrence of a trouble in any POS terminal due to various causes in such a manner that the data, which have heretofore been managed but a master unit and a back-up unit along, are commonly held by all the POS terminal units. In this embodiment, the individual data processing units (i.e., the POS terminal units 11 to 13) have similar construction and functions.

In FIG. 1 embodiment, a so-called hierarchical control system is constituted with the POS terminal unit 11, which 1s an arbitrarily selected, among the plurality of POS terminal units 11 to 13 set as master unit and the other POS terminal units 12 and 13 set as slave units.

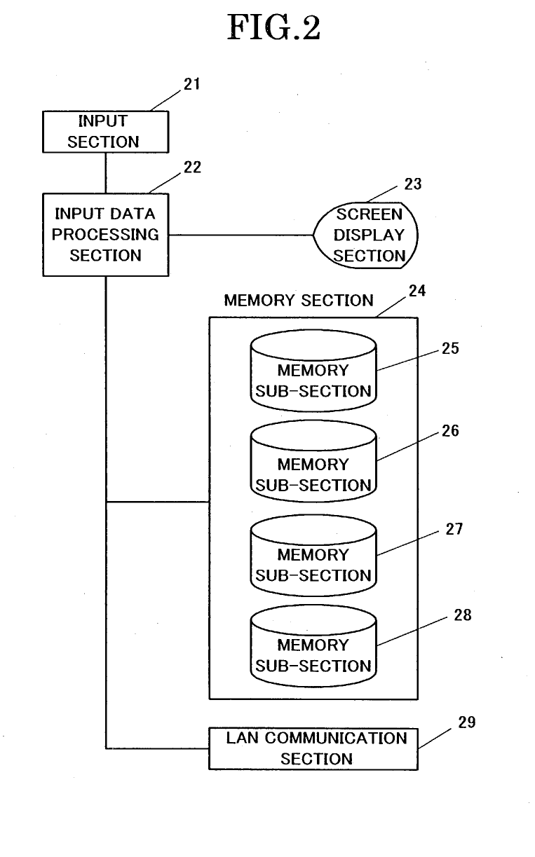

FIG. 2 is a block diagram showing the construction of the POS terminal units 11 to 13 as the data processing units having similar construction and functions shown in FIG. 1. Each data processing unit (or POS terminal unit) includes an input section 21 used for menu registration and the like, an input data processing section 22 serving as data processing function section for processing data received by the input section 21, a screen display section 23 for displaying data received by the input unit 21 on the screen based on the output of the input data processing section 22, a memory section 24 serving as data accumulating function section for storing the data received by the input section 21 and other data to be described later based on the output of the input data processing section 22, and a LAN communication section 29 serving as data communication function section for carrying out data communication between POS terminal units via LAN. The memory section 24 has a plurality of memory sub-sections 25 to 28, in which data fed from the input section 21 and also data obtained through a LAN communication section 29 are accumulated.

In the POS terminal unit 12 (see FIG. 1), when a sales processing of the input section 21, the input data processing section 22 in FIG. 2 causes sales data to be stored in the memory sub-sections 25 to 27 in the memory section 24. Also, the sales data which have been stored through the LAN communication section 29 in the memory sub-sections 25 to 27 as described before, are transmitted to the POS terminal unit set as master unit (i.e., POS terminal unit 11 in this embodiment) among the LAN connected POS terminal units.

The POS terminal unit 11 receiving the data, stores the received data in the memory sub-sections 25 to 27 in the memory section 24. Subsequently, the master unit transmits the received data to all the LAN connected terminals (in this case the POS terminal unit 13) except for the own terminal (i.e., the POS terminal unit 11) and the POS terminal unit as the source (in this case the POS terminal unit 12). The terminals receiving the data (in this case the POS terminal unit 13) store the received data in the memory sub-sections 25 to 27 in the memory section 24. As a result, the contents of the data stored in the memory sub-sections 25 to 27 in the memory sections (i.e., data accumulating function sections) 24 in all the LAN connected POS terminal units (i.e., data processing units) become the same.

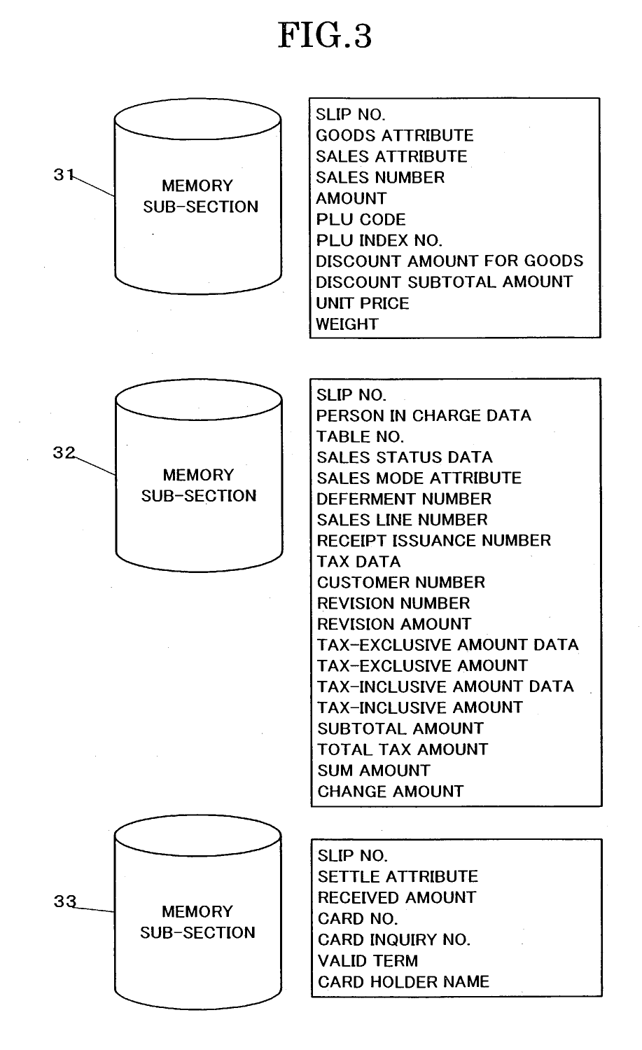

FIG. 3 is a view showing in details the status of the data accumulation in the memory sub-sections 25 to 27 in the memory section 24 in FIG. 2. The memory sub-section 25 is shown as member sub-section 31 in FIG. 3. Likewise, the memory sub-sections 26 and 27 in FIG. 2 are shown as memory sub-sections 32 and 33, respectively.

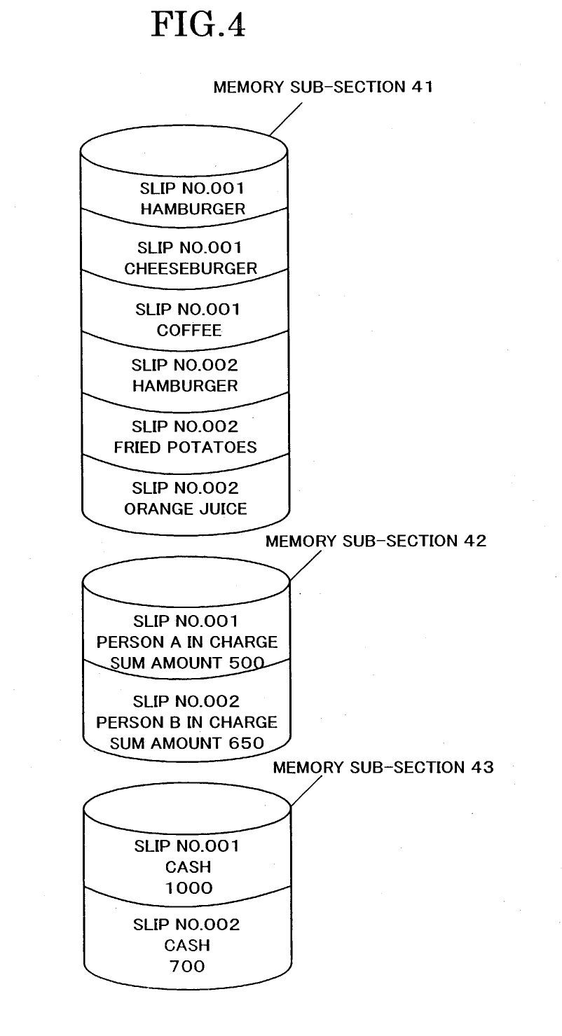

It is now assumed, as an example, that in the POS terminal unit 12 a person A in charge made sales processing of hamburger, cheeseburger and coffee and received 1, 000 yen and a next person B in charge made sales processing of hamburger, fried potato and orange juice. It is also assumed that the slip Nos. concerning the respective sales processing at this time are “001” and “002”. At this time, the data in the memory sub-sections 25 to 27 in the memory section 24 in the POS terminal unit 12, are as shown as memory sections 41 to 43 in FIG. 4.

In this system, the unit of data transmitted in one time of communication is one account unit. In the above example, the data which were transmitted to the other POS terminal units (i.e., POS terminal unit 11 as master unit) when the person B made the sales processing of hamburger, fried potato and orange juice, are the sale data of this time, not including the existing data before the occurrence of the sales, that is, only the data corresponding to the slip No. “002”.

As shown above, the present invention can be summarized as a data back-up method characterized in that, at the time of occurrence of data updating sales data input to input section 21), in one of the plurality of data processing units (or POS units) (i.e., POS terminal unit 12), of data of at least a predetermined kind (sales data being pertinent) among the data held in the own data accumulating function section (i.e., memory section 24 having the individual memory sub-sections), the data processing unit concerning the occurrence of the data updating (i.e., the POS terminal unit 12 in the above example) is caused to transmit the contents of the data updating to all other data processing units (i.e., POS terminal units 11 and 13) via the data transfer line (i.e., LAN communication section 29, hub 14), thereby causing all the other data processing units (i.e., POS terminal units 11 and 13) having received the data updating contents (i.e., inputted sales data of this time) to revise the contents of the data held in the own data accumulating function sections to the state reflecting the data updating, and allowing, in response to the revision, all the plurality of data processing units (i.e., POS terminal units 11 to 13) to be in a sate that data of the same contents concerning at least the data of the predetermined kind is held in the own data accumulating function sections.

In connection with allowing, in the above data back-up method, all the plurality of data processing units (i.e., POS terminal units 11 to 13) to be in a state that data of the same contents concerning at least the data of the predetermined kind is held in the own data accumulating function sections, as described before in connection with FIGS. 1 and 2, it is also possible to construct a hierarchical control system with one of the plurality of data processing units as master unit (i.e., the POS terminal unit 11 set as master unit) and all the others set as slave units. In this case, at the time of occurrence of data updating (i.e., sales data input), in one of the data processing units as the slave units (i.e., the POS terminal unit 12 in the above example), of data of at least a predetermined kind of the data held in the own data accumulating function section, this data processing unit is caused to transmit the contents of the data updating to the data processing unit as the master unit (i.e., the POS terminal unit 11) for revising the contents of the data held in the data accumulating function section in that unit to the state reflecting the data updating, and then the data processing unit as the master unit is caused to transmit data concerning the data updating to the data processing units other than the own unit (i.e., POS terminal unit 11) and the data processing unit as the slave unit concerning the data updating (i.e., POS terminal unit 12) via the data transfer line to cause the data processing units as the slave units having received the contents of the data updating via the data transfer line (i.e., POS terminal unit 13) to revise the contents of the data held in the own data accumulating function sections, thereby allowing, in response to the execution of the revision, all the plurality of data processing units to be in a state that the data of the predetermined kind is held in the own data accumulating function sections.

When data updating, in the data processing unit as the master unit (i.e., POS terminal unit 11), of data of a predetermined kind (i.e., sales data) among the data held in the own data accumulating function section, this unit is caused to transmit the contents of the data updating to he data processing units as the slave unit (POS terminal units 12 and 13) to cause revision of the contents of the data held in the data accumulating function sections in these units to the state reflecting the data updating.

As shown above, according to the present invention the LAN connected POS terminal units hold sales data in similar fashions. Thus, even in the event of trouble occurrence in any POS terminal unit, loss of sales data does not occur owing to the fact that the same data are stored in the other POS terminal units as well.

In addition, in the prior art, when tentatively retaining sales data and later calling out these data, it has been necessary to make inquiry to a master unit or a back-up unit as terminal unit and receive the data from such terminal, thus inevitably taking a communication time. In the system according to the present invention, it is necessary only to call the sales data held in the own data accumulating function section (i.e., memory section). That is, it is not necessary to make inquiry to any master unit or back-up unit, thus leading to reduction of the communication time and also reduction of the retained data call time.

While the above description has concerned with the case of using POS terminal units of a type dealing with sales data, it is also possible to use, as the data processing units (or POS terminal units), those of a type selectively dealing with sales data and diligence/non-diligence data or either one of the data of these two kinds and deal with the sales data and/or the diligence/non-diligence data as those corresponding to the above data of the predetermined kind.

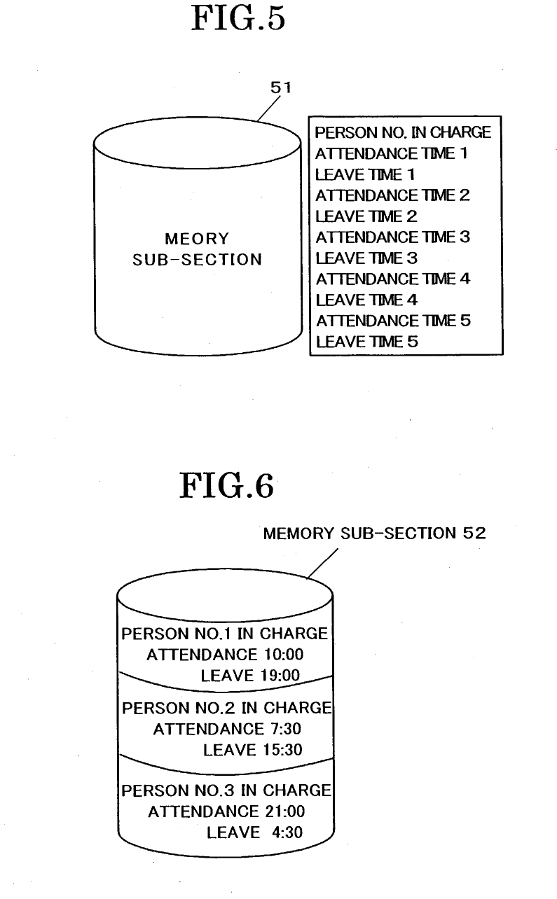

As an embodiment of this type, a memory sub-section 28 for storing the diligence/non-diligence data like the sales data is provided in the memory section 24 shown in FIG. 2. FIG. 5 is a view for describing details of data accumulation status in the memory sub-section 28 in FIG. 2. In FIG. 5, a memory sub-section 51 corresponds to the memory sub-section 28 in FIG. 2. FIG. 6 is a view for describing details of data accumulation status in a different example of memory sub-section 28 in FIG. 2. In the Figure, a memory sub-section 52 corresponds to the memory sub-section 28 in FIG. 2.

When an on-work or off-work processing is started in a certain terminal (i.e., POS terminal unit), the input data processing section 22 in FIG. 2 stores the input data in the memory sub-section 28 in the memory section 24. The LAN communication section 29 transmits the diligence/non-diligence data stored in the memory sub-section 28 to the terminal unit selected as master unit (here POS terminal unit 11) among the LAN connected terminals. The master unit receiving the data (i.e., POS terminal unit 11) stores the received data in the memory sub-section 28 in the memory section 24. Then, the master unit (i.e., POS terminal unit 11) transmits the received diligence/non-diligence data to all the LAN connected terminals other than the own unit and the diligence/non-diligence source terminal unit (i.e., POS terminal unit 13 in this example). The POS terminal units receiving the diligence/non-diligence data (here POS terminal unit 13) store the received data in the memory sub-sections 28 in the own memory sections 24. As a result, the contents of data in the memory sub-sections 28 become the same concerning the diligence/non-diligence data in the memory sections of all the LAN connected terminal units.

When making the data inquiry of past diligence/non-diligence in the above method, it is not necessary to make inquiry to any master unit or back-up unit, thus leading to reduction of communication time and also call time.

As has been described in the foregoing, according to the present invention, all the plurality of data processing unit (for instance POS terminal units) can be in a state that data of the same contents so far as data of at least a predetermined kind are held in the own data accumulating function sections. Thus, it is possible to provide as data back-up method and a system for carrying out the method, which can preclude a prior art problem that, at the time of trouble occurrence in a unit which should hold master data or in a data transfer line connected to that unit for data transmission and reception, it is necessary, for having a unit holding back-up data to function in lieu of a unit which intrinsically holds master data, to execute such complicated operations as switching the data flow or urgently setting up a state of communication with back-up data (or file thereof).

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

What is claimed is:

1. A data back-up method comprising the steps of:
interconnecting a plurality of data processing units each having a data processing function section, a data accumulating function section and data communication function section with data transfer line, permitting interchange of own held data of the plurality of data processing units interconnected by the data transfer line and permitting accumulation of own received data in the own data accumulating function section;
causing, at the time of occurrence of updating, in one of the plurality of data processing units, of data of at least a predetermined kind among the data held in the own data accumulating function section, the data processing unit concerning the updating occurrence to transmit the contents of the updating to all the other data processing units via the data transfer line;
causing all the other data processing units having received the updating contents via the data transfer line to revise data held in the own data accumulating function sections to the state reflecting the updating; and
allowing, in response to the revision, all the plurality of data processing units to be in a state that data of the same contents concerning at least the data of the predetermined kind is held in the own data accumulating function sections.

2. A data back-up method comprising the steps of:
interconnecting a plurality of data processing units each having a data processing function section, a data accumulating function section and data communication function section with data transfer line, permitting interchange of own held data of the plurality of data processing units interconnected by the data transfer line and permitting accumulation of own received data in the own data accumulating function section;
constituting a hierarchical control system with one of the plurality of data processing units set as a master unit and the others as slave units;
causing, at the time of occurrence of updating, in one of the data processing units as the slave units, of data of at least a predetermined kind among the data held in the own data accumulating function, the afore-said slave unit concerning the updating occurrence to transmit the updated data to the data processing unit as the master unit, thereby causing revision of the contents of data in the data accumulating function section in the master unit to the state reflecting the updating;
then causing the data processing unit as the master unit to transmit the data concerning the data updating to the data processing units other than the own unit and the data processing unit as the slave unit concerning the data updating via pertinent data transfer line;
causing the data processing units as the slave units having received the contents of the data updating via the data transfer line to revise the contents of data held in the own data accumulating function sections to the state reflecting the data updating; and
allowing, in response to the revision, all the plurality of data processing units to be in a state that data of the same contents concerning at least the data of the predetermined kind is held in the own data accumulating function sections.

3. The data back-up method according to claim 2, wherein at the time of occurrence of data updating, in the data processing unit as the master unit, of data of at least a predetermined kind among the data held in the own data accumulating function section, the contents of the data updating are caused to be transmitted to the data processing unit as the slave unit for the revision of the contents of the data held in the data accumulating function sections to the state reflecting the data updating.

4. The data back-up method according to one of claims 1 or 2, wherein the data processing units are POS terminal units.

5. The data back-up method according to claim 4, wherein the POS terminal units are of a type of dealing with sales data and/Or diligence/non-diligence data, the sales data and/or the diligence/non-diligence data being dealt with as data corresponding to the data of the predetermined kind.

6. The data back-up method according to one of claims 1 and 2, wherein the data processing units are POS terminal units of a type dealing with sales data and/or diligence/non-diligence data, the sales data and/or diligence/non-diligence data being deal with as data corresponding to the data of the predetermined kind.

7. A data back-up system comprising a plurality of data processing units having a data processing function section, a data accumulating function section and a data communication function section, the data processing units being constructed such that their data communication function sections are interconnected via predetermined common data transfer line and are capable of interchanging data held in their data accumulating function sections via the data transfer line, wherein:
each of the plurality of data processing units is constructed such that, at the time of occurrence of data up-dating of data of a predetermined kind among data held in the own data accumulating function section, it transmits the contents of the data updating to all the other data processing units interconnected by the data transfer line and, at the time of the contents of data updating from any other data processing unit via the pertinent data transfer line, revises the contents of the data held in the own data accumulating function section to the state reflecting the data updating; and
in response to the execution of the revision, all the plurality of data processing units are allowed to be in a state that data of the same contents concerning at least the data of the predetermined kind is held in the own data accumulating function sections.

8. A data back-up system comprising a plurality of data processing units having a data processing function section, a data accumulating function section and a data communication function section, the data processing units being constructed such that their data communication function sections are interconnected via predetermined common data transfer line and are capable of interchanging data held in their data accumulating function sections via the data transfer line, wherein: the plurality of data processing units are constructed such as to fit hierarchical control with the own unit set as master unit and the others as slave units or hierarchical control with the own unit set as slave unit and the others as master units;
in the case with the own unit set as master unit, when data updating of data of at least a predetermined kind among data held in the data accumulating function section in any data processing unit set as slave unit occurs, the own unit as the master unit causes the contents of the data updating to be transmitted to the own unit as the master unit via the data transmission line to revise the contents of data held in the own data accumulating function section to the state reflected by the data updating, and then transmits data concerning the data updating to the data processing units other than the own unit and the data processing unit as the slave unit concerning the data updating via the data transfer line; and
in the case with the own unit set as slave unit, when data updating of data of at least a predetermined kind among data held in the own data accumulating function section occurs, the own unit as the slave unit transmits the updated data to the data processing units set as the master units via the data transfer line and, when it receives data concerning data updating from any data processing unit set as master unit via the data transfer line, it revises the contents of data held in the own data accumulating function section to the state reflecting the data updating; and
in response to the execution of the revision, all the plurality of data processing units are allowed to be in a state that data of the same contents concerning at least the data of the predetermined kind is held in the own data accumulating function sections.

9. The data back-up system with the own data processing unit set as master unit according to claim 8, when data updating of data of at least a predetermined kind among data held in the own data accumulating function section occurs, the own unit causes the transmission of the contents of the data updating to the data processing units as the slave units for revision of the contents of the data held in the individual data accumulating function sections to the state reflecting the data updating.

10. The data back-up system according to one of claims 7 and 8, wherein the data processing units are POS terminal units.

11. The data back-up system according to claim 10, wherein the POS terminal units are of a type dealing with sales data and/or diligence/non-diligence data.

12. The data back-up system according to one of claims 7 an 8, wherein the data processing units are of a type dealing with sales data and/or diligence/non-diligence data, the POS terminal units deal with the sales data and/or diligence/non-diligence data as data corresponding to the data of the predetermined kind.
